(19) United States
(12) Patent Application Publication
(10) Pub. No.: US 2014/0259930 A1
(43) Pub. Date: Sep. 18, 2014

(54) PORTABLE GATE

(71) Applicant: Chester A. Gilliam, Castle Rock, CO (US)

(72) Inventor: Chester A. Gilliam, Castle Rock, CO (US)

(21) Appl. No.: 14/208,494

(22) Filed: Mar. 13, 2014

Related U.S. Application Data
(60) Provisional application No. 61/778,954, filed on Mar. 13, 2013.

(51) Int. Cl. E01F 13/04; E01F 13/02; E05F 15/14

(52) U.S. Cl. CPC E01F 13/04; E05F 15/14; E01F 13/02
USPC 49/70; 49/360; 49/506; 49/349; 49/352

(57) ABSTRACT

An example portable gate includes a platform. A frame is mounted to the platform, the platform configured to support a portable weight. A gate is movably supported by the frame. A drive system is configured to open and close the gate in both right-hand operation and left-hand operation based only on direction of travel of the drive system without other modification. A control panel may be operatively associated with the drive system to operate and/or configure operation of the portable gate.

### PRIORITY CLAIM

This application claims the benefit of U.S. Provisional Patent Application No. 61/778,954 filed Mar. 13, 2013 titled “Portable Gate” of Chester A. Gilliam, hereby incorporated by reference for all that it discloses as though fully set forth herein.

### BACKGROUND

Security gates may be used anywhere controlled access is desired. Examples include, but are not limited to, military installations or other sensitive areas (government or business), and even neighborhoods and some individual private homes. However, sometimes controlled access is needed only on a temporary basis, such as to block roads during emergencies (e.g., forest fires, flooding, or other natural disasters), or on a seasonal basis (e.g., access to forest roads during the summer which are closed during the winter). Gates either have to be installed permanently and opened/closed on an as-needed basis. Or temporary road blocks (e.g., concrete blocks) need to be brought in, or the roads blocked using emergency vehicles.

### BRIEF DESCRIPTION OF THE DRAWINGS

FIG. 1 is an illustration of an example portable gate.

FIG. 2 is an illustration of an example drive system of the portable gate.

FIG. 2A is an illustration of another example drive system of the portable gate.

FIG. 3 is an illustration of an example control panel of the portable gate.

FIG. 4 is an illustration of an example lower roller system of the portable gate.

FIG. 4A is an illustration of another example lower roller system of the portable gate.

FIG. 5 is an illustration of an example upper roller system of the portable gate.

FIG. 6 is an illustration of an example platform of the portable gate.

FIG. 7 is an illustration of an example portable gate with solar panel.

FIGS. 8A and 8B illustrate another example portable gate.

### DETAILED DESCRIPTION

A portable gate is disclosed. An example of the portable gate can be readily transported (e.g., by trailer) and placed for operation to open and close across a road or entrance. The portable gate may be sufficiently heavy and/or anchored in place so that it cannot be readily removed (e.g., to perpetrate the gate). The portable gate can be used in any orientation (e.g., right-hand or left-hand operation). In an example, the portable gate can be powered by battery, solar power, or other portable energy source. In another example, the portable gate can be powered by connecting to a permanent energy source (e.g., the electricity grid). As such, the portable gate can be used on a permanent, semi-permanent, or temporary basis. Safety features may be built-in, for example, to stop operation of the gate if an object (such as a person or vehicle) is detected in the path of the gate.

Before continuing, it is noted that as used herein, the terms “includes” and “including” mean, but is not limited to, “includes” or “including” and “includes at least” or “including at least.” The term “based on” means “based on” and “based at least in part on.”

FIG. 1 is an illustration of an example portable gate. In an example, the portable gate includes a platform 1 which supports a frame 2. The frame 2 may support any number of gates 3, including positionable gate(s) and/or a stationary gate(s).

The gate 3 is shown having bars 5 that run in a vertical direction, although any configuration (horizontal, mesh) may be used so as to restrict access through the gate 3. In an example, the gate 3 may be about 12 feet to 20 feet in length/width, and about 4 feet to 8 feet in height. However, other dimensions are also possible.

Rollers 6 may be configured to support movement of the positionable gate 3 from an open to a closed position. In the example shown, the portable gate is in an in-use or closed position, wherein the gate 3 is extended to the left side of the platform 1 and frame 2 such as it may be extended across a driveway, road, path, or other passageway.

In an example, the portable gate may be cantilevered, e.g., based on the size and position of the platform, and weight that is added to anchor the platform, so that the portable gate does not tip over during extension of the gate 3.

It is noted that the gate 3 may be extended to the left side (shown) and/or right side (wherein gate portion 4 moves out to the right of FIG. 1). This multi-directional movement enables the platform 1 to be positioned wherever it is most convenient, without restricting its operation. In an example, the portable gate is operated by a drive system, including a motor box 8. The motor box 8 is shown open in FIG. 2.

In an example, a drive motor 8a is housed in motor box 8. The motor box 8 is shown in FIG. 1 attached to the frame 2. However, the motor box 8 may be positioned in any suitable location. The motor 8a may be powered by a battery (e.g., housed in battery box 17 shown in FIG. 3), e.g., in the motor box 8 or other suitable location, or via a cord 11 extending to a generator or other electrical connection. See also, the example solar panel 16 shown in FIG. 7.

The drive system is also shown in FIGS. 1 and 2 including a chain 9 attached to either end of the gate 3 and fitted through the drive box 8, for operation by the drive motor 8a (shown in FIG. 2). The motor 8a may be operatively associated with a gear 8b connected for example by a belt 8c that rotates the gear 8b. The chain 9 interlocks with the gear 8b such that the chain 9 is moved in a first direction (e.g., to the left) and/or in a second direction (e.g., to the right).

FIG. 2A is an illustration of another example drive system of the portable gate. Again, chain 9 is attached to either end of the gate 3 and fitted through the drive box 8, for operation by the drive motor 8a. The motor 8a may be operatively associated with a rollers and/or gears 8d and 8e. The motor 8a rotates a central drive gear and the chain 9 interlocks with the gears (and/or rollers) such that the chain 9 is moved in a first direction (e.g., to the left) and/or in a second direction (e.g., to the right).

Still other implementations of the drive system are contemplated. It is also noted that the portable gate is not limited to use with a chain drive. For example, the gate 3 may be operated by other mechanisms including but not limited to cable(s), gear drive, and direct drive.

In the example shown in the Figures, the chain 9 is attached to the positionable gate 3, such that when the chain 9 is moved in either direction by the drive motor 8a, the chain 9 opens and closes the positionable gate 3. As a result, the gate 3 is pulled in one direction or the other based on the direction of operation of the drive motor 8a. In an example, the drive box 8 may be further supported by a horizontal beam 12 and/or other support member(s).

In an example, the drive system may also include a chain stop 10 (see FIG. 2). The chain stop may prevent the chain 9 from over-traveling and hence causing the gate 3 to come off the rail (or rollers). In an example, the chain stop 10 is mechanical, engaging the motor box 8 and stopping travel of the chain in the case that the motor 8 continues to operate. In another example, the chain stop 10 may engage an electrical switch, wherein actuating the electrical switch stops operation of the motor when the gate is in the closed position. The chain stop 10 may be selectively positioned on the chain 9 to enable any desired travel of the gate 3.

The gate 3 may be configured for multi-directional operation. For example, the gate 3 may be configured for right-hand operation (e.g., opening and closing on the right-hand side of the platform); and/or left-hand operation (e.g., opening and closing on the left-hand side of the platform). In an example, the gate 3 can be operated in either or both direction based on direction of operation of the drive motor 8a and without needing any other modification to the gate 3 and/or other aspects of the portable gate. Operation of the gate 3 may be pre-configured from the manufacturer and/or configured by the end-user.

In an example, operation and/or configuration of the portable gate is via control panel 7. The gate may be operated in response to input from the user via control panel 7, such as a passcode or security PIN. For example, entry of the correct passcode or security PIN may result in a signal being generated which activates operation of the motor 8a. The user may also program or otherwise configure operation of the gate (e.g., for right-hand and/or left-hand operation; length of travel of the gate 3; user code setup, etc.).

FIG. 3 is an illustration of an example control panel 7 of the portable gate. In this example, the control panel 7 is a keypad. However, the control panel 7 may include any suitable input or input/output device. For example, the control panel 7 may include a computing device or other programmable device to operate and/or configure operation of the portable gate. In addition, a remote control may be provided (e.g., card reader or other reader device and/or via mobile phone or other remote communications device).

In an example, the control panel 7 enables the portable gate to be operated in a stand-alone mode (i.e., without a manual operator). It is noted, however, that the portable gate may be operable on-site and/or remotely. The control panel 7 may also enable the portable gate to be linked with other equipment (e.g., lighting, alarm systems, etc.). For example, the gate may close based on a signal received from an alarm, or the gate may open based on a signal from a security camera (or biometrics or motion sensors).

The control panel 7 may be housed in a protective box 13 that shields it from water or other damage. The control panel 7 can be accessed to operate the portable gate (e.g., to actuate the drive motor 8a and/or control direction of travel of the gate 3). A conduit 14 may connect the control panel 7 to the drive motor 8a.

Referring again to FIG. 1, FIG. 1 shows the portable gate with the gate 3 opened to the right of the platform. The drive motor 8 may be for instance switched to pull the chain 9 in an opposite direction to position the gate 3 on the other side. In an example, the gate 3 travels by way of a roller system. Roller system may include a plurality of rollers 6 (e.g., as shown in FIG. 1).

FIG. 4 is an illustration of an example lower roller system of the portable gate. In this example, the lower roller system lower rollers 6 which support and guide travel of the gate 3 during operation to open and close the gate. One of the lower rollers 6 is shown as it may be fitted on a carriage 41 connected to the frame 2, e.g., with bolts 42. FIG. 4A is an illustration of another example lower roller system of the portable gate. The example roller system shown in FIG. 4A may be at least partly housed by the gate 3 so as to reduce dirt buildup and/or damage to the rollers. FIG. 5 is an illustration of an example upper roller system of the portable gate. A carriage 51 is shown as it may attach the upper rollers 6 to the frame 2. Bolts 52 may be used to attach the carriage 51 to the frame 2. A similar roller system as that shown in FIG. 4A may also be used as the upper roller system.

Of course, other examples are also contemplated, and the portable gate is not limited to use with any particular type or configuration of roller system. Indeed, a roller system is not even needed, as a similar travel system may be implemented using slider(s) or other mechanisms of travel for gate 3.

FIG. 6 is an illustration of an example platform 1 of the portable gate. The platform 1 supports the frame 2 and may be of suitable dimensions to the support the gates both in closed and in in-use or open positions.

In an example, the platform 1 is configured as a skid which can be readily loaded by forklift for transport on a flatbed truck or trailer. For example, the skid may include openings 15 formed therein for receiving the arms of a forklift. However, the platform 1 is not limited to such a configuration.

The platform 1 is shown in FIG. 6 as it may be sufficiently heavy (e.g., manufactured of steel or other metal) such that it can only be moved using heavy equipment.

FIGS. 8A and 8B illustrate another example portable gate. Reference numbers are designated a prime (′) to indicate like components. It is noted that the roller system shown in detail in FIG. 4A is shown as it may be implemented in the configuration of the portable gate shown in FIGS. 8A and 8B. In addition, the gate 3′ includes wire mesh instead of the bar configuration shown for gate 3.

FIGS. 8A and 8B also illustrate the use of portable barriers to further ensure the platform 1 cannot be readily removed without authorization. In this example, additional weight(s) 20 (e.g., concrete block, and/or sand or water-filled barriers) may be added on the platform 1′. For example, the platform may be specifically sized to receive standard road barriers. As such, the platform 1′ may be of a size and weight to support or counterweight the gate 3′ such that the entire portable gate structure will not tip (e.g., when the gate 3′ is in the extended position, or by impact of wind or vehicle). Weights 20 may also be used with the configuration shown in FIG. 1, and with other configurations of the portable gate.

To further ensure the platform 1 or 1′ cannot be readily removed without authorization, the platform 1 or 1′ may be staked (e.g., through a lattice mesh floor shown in FIG. 6). In another example, the platform 1 or 1′ may include one or more hooks, or other anchor points (not shown), so that the platform 1 or 1′ can be anchored to a base (e.g., the ground, a road) using stakes.

It is noted that the examples shown and described are provided for purposes of illustration and are not intended to be limiting. Still other examples are also contemplated.

1. A portable gate comprising:
a platform with a frame, the platform configured to support a portable weight;
a gate supported by the frame; and
a drive system configured to open and close the gate in both right-hand operation and left-hand operation based only on direction of travel of the drive system without other modification.

2. The portable gate of claim 1, wherein the platform is a metal skid configured for moving by a forklift and for transport on a flatbed truck or trailer.

3. The portable gate system of claim 1, wherein the platform is configured to be anchored to a base by at least one stake.

4. The portable gate system of claim 1, wherein the platform is configured to be anchored to a base by a road barrier positioned on the platform.

5. The portable gate of claim 1, further comprising a rail system to guide the gate during operation to open and close the gate.

6. The portable gate of claim 1, wherein the drive system includes a drive motor operatively associated with a gear, the gear operatively associated with the gate such that a direction of operation of the drive motor directly translates to direction of operation of the gate.

7. The portable gate of claim 1, wherein the drive motor is powered by a stand-alone power source including at least one of battery, generator, and solar power.

8. The portable gate of claim 1, wherein the gate is operable based on input from external security equipment.

9. The portable gate of claim 1, further comprising a control panel to configure operation of the gate.

10. The portable gate of claim 1, further comprising a control panel to receive user input to open and close the gate.

11. A portable gate comprising:
a platform configured to support a portable weight thereon;
a frame mounted to the platform;
a gate movably supported by the frame;
a drive system configured to open and close the gate in both right-hand operation and left-hand operation based only on direction of travel of the drive system without other modification; and
a control panel operatively associated with the drive system.

12. The portable gate of claim 11, further comprising a chain attached to opposite ends of the gate, the chain driven by the drive system.

13. The portable gate of claim 11, further comprising a chain stop to limit travel of the gate.

14. The portable gate of claim 11, wherein the drive system includes a gear drive.

15. The portable gate of claim 11, wherein the control panel is operable to configure operation of the gate.

16. The portable gate of claim 1, wherein the control panel is operable to receive user input to open and close the gate.

17. The portable gate of claim 11, wherein the platform is a metal skid configured for moving by a forklift and for transport on a flatbed truck or trailer.

18. The portable gate system of claim 1, wherein the platform is configured to be anchored to a base by at least one stake and by at least one road barrier positioned on the platform.

19. A method of providing a portable gate in a remote location, the method comprising:
providing a platform for delivery to the remote location;
stabilizing the portable gate with a portable weight on the platform;
supporting a gate in a frame mounted to the platform; and
configuring a drive system to open and close the gate in both right-hand operation and left-hand operation based only on direction of travel of the drive system without other modification.

20. The method of claim 19 further comprising providing the platform as a metal skid configured for moving by a forklift and for transport on a flatbed truck or trailer.
